(19) United States
(12) Patent Application Publication
(10) Pub. No.: US 2020/0230630 A1
(43) Pub. Date: Jul. 23, 2020

(54) PAINTING SYSTEM AND PAINTING METHOD

(71) Applicant: HONDA MOTOR CO., LTD., Minato-ku, Tokyo (JP)

(72) Inventors: Hiroki Matsunaga, Hagagun, Tochigi-ken (JP); Masaki Shigekura, Hagagun, Tochigi-ken (JP); Masayuki Yamaguchi, Hagagun, Tochigi-ken (JP); Takashi Wakimoto, Hagagun, Tochigi-ken (JP); Yusuke Kawaguchi, Hagagun, Tochigi-ken (JP); Satoshi Sakamoto, Hagagun, Tochigi-ken (JP)

(21) Appl. No.: 16/634,888

(22) PCT Filed: Aug. 1, 2018
(86) PCT No.: PCT/JP2018/028834

§ 371 Date: Jan. 29, 2020

(30) Foreign Application Priority Data
Aug. 1, 2017 (JP) 2017-149114

(51) Int. Cl. B05B 7/28; B05B 15/20; B05B 13/04; B05D 1/02; B01F 3/08; B01F 15/04; B01F 15/00

(52) U.S. Cl. CPC B05B 7/28; B05B 15/20; B05B 13/0431; B01F 2215/005; B01F 3/088; B01F 15/0416; B01F 15/00019; B05D 1/02

(57) ABSTRACT

A painting system used in a painting method in which a plurality of colors of paint supplied from a paint supply device are mixed and toned with a mixing device and applied to a workpiece, the painting system comprising a storage unit that can store the paint that is mixed and toned with the mixing device, and a cleaning unit that can clean the mixing device. When applying the paint in the storage unit to the workpiece, the cleaning unit cleans the mixing device.

### TECHNICAL FIELD

The present invention relates to a painting system and a painting method for mixing and toning a plurality of colors of paint, supplied from a paint supply apparatus, with a mixing apparatus and painting a workpiece.

### BACKGROUND ART

As an example, Japanese Laid-Open Patent Publication No. 2005-103384 proposes a painting system that mixes and tones a plurality of colors of paint, supplied from a plurality of tanks, with a mixing apparatus and continuously guides the paint from the mixing apparatus to a painting device (painting gun).

### SUMMARY OF INVENTION

However, in the conventional technology described above, since the paint inside the mixing apparatus is continuously guided to the painting device, when the color of the paint is to be changed, it is necessary to clean the mixing apparatus after the painting of the workpiece by the painting device is finished. Therefore, there is concern that the color of the paint cannot efficiently be changed.

The present invention has been devised in order to solve this type of problem, and has the objective of providing a painting system and a painting apparatus capable of efficiently performing the operation of changing the color of the paint.

In order to achieve the above objective, a painting system according to the present invention is a painting system that mixes and tones a plurality of colors of paint, supplied from a paint supply apparatus, with a mixing apparatus and paints a workpiece, and comprises a mixing ratio calculating section that calculates a mixing ratio of colors of paint necessary for toning; a supply amount calculating section that calculates a supply amount of each color of paint based on the mixing ratio; the paint supply apparatus that supplies the mixing apparatus with an amount of each color of paint necessary for toning corresponding to the supply amount calculated by the supply amount calculating section; the mixing apparatus that is capable of mixing and toning the plurality of colors of paint supplied from the paint supply apparatus; a storage section that is capable of storing the paint that has been mixed and toned by the mixing apparatus; a painting section that is capable of painting the workpiece with the paint inside the storage section; a transport apparatus that is provided with the storage section and transports the painting section; and a cleaning section that is capable of cleaning the mixing apparatus.

According to the above configuration, it is possible to transfer the paint that has been mixed and toned by the mixing apparatus to the storage section. Therefore, it is possible to clean the mixing apparatus while painting the workpiece using the paint inside the storage section. Accordingly, it is possible to efficiently perform the operation of changing the paint color.

The painting system may further comprise an intermediate storage section that is capable of storing the paint that has been mixed and toned by the mixing apparatus, and the paint stored inside the intermediate storage section may be capable of being transferred to the storage section.

According to the above configuration, it is possible to transfer the paint that has been mixed and toned by the mixing apparatus to the intermediate storage section while painting the workpiece with the paint inside the storage section. Therefore, it is possible to more efficiently perform the operation of changing the paint color.

The painting system may comprise a CCV for selectively guiding, to the intermediate storage section, paint supplied from the paint supply apparatus that does not pass through the mixing apparatus and paint supplied from the paint supply apparatus that has been mixed and toned by the mixing apparatus.

According to the above configuration, it is possible to selectively paint the workpiece with the paint (normal color paint) supplied from the paint supply apparatus without passing through the mixing apparatus and the paint (special color paint) mixed and toned by the mixing apparatus. Therefore, it is possible to paint the vehicle body W selectively with the normal color paint and special color paint. Furthermore, since it is possible to share (commonize) the intermediate storage section, the storage section, and the painting section between a case where the vehicle body is painted with the normal color paint and a case where the vehicle body is painted with the special color paint, it is possible to make the painting system more compact and to lower equipment costs.

The painting system may further comprise a first transfer passage through which the paint inside the intermediate storage section is guided; a first connecting section provided to the first transfer passage; a second connecting section that is capable of being attached to and detached from the first connecting section; and a second transfer passage that causes communication between the second connecting section and the storage section, and, in a state where the second connecting section is attached to the first connecting section, the paint inside the intermediate storage section may be capable of being transferred to the inside of the storage section via the first transfer passage, the first connecting section, the second connecting section, and the second transfer passage.

According to the above configuration, when it is necessary to supply paint to the storage section, it is possible to transfer the paint in the intermediate storage section to the storage section by attaching the second connecting section to the first connecting section. Furthermore, when the vehicle body is to be painted, it is possible to separate the intermediate storage section and the storage section from each other by removing the second connecting section 106 from the first connecting section.

Accordingly, there is no need to lengthen the passage between the intermediate storage section and the storage section to match the operating range of the transport apparatus.

A painting method according to the present invention is a painting method for mixing and toning a plurality of colors of paint, supplied from a paint supply apparatus, with a mixing apparatus and painting a workpiece, and the painting method comprises a mixing ratio calculating step of calculating a mixing ratio of colors of paint necessary for toning; a supply amount calculating step of calculating, based on the mixing ratio calculated in the mixing ratio calculating step, a supply amount of each color of paint to be supplied from the paint supply apparatus to the mixing apparatus; a paint supplying step of supplying the mixing apparatus with an amount of each color of paint necessary for toning corresponding to the supply amount calculated in the supply amount calculating step; a mixing step of mixing and toning the plurality of colors of paint supplied to the mixing apparatus; a transfer step of transferring the paint that has been mixed and toned in the mixing step to a storage section provided to a transport apparatus; a painting step of guiding the paint inside the storage section to a painting section provided to the transport apparatus and painting the workpiece; and a cleaning step of cleaning the mixing apparatus, wherein the cleaning step is performed during the painting step.

According to this method, the same effects as realized by the painting system described above are realized.

In the painting method described above, the transfer step may include a first transfer step of transferring the paint that has been mixed and toned in the mixing step to the intermediate storage section; and a second transfer step of transferring the paint in the intermediate storage section to the storage section, and the cleaning step may be performed during the second transfer step.

According to this method, it is possible to perform the operation of switching the paint color even more efficiently.

The painting method described above may comprise a normal painting step of transferring, to the storage section, the paint supplied from the paint supply apparatus to the intermediate storage section without passing through the mixing apparatus and painting the workpiece, and at least one of the mixing ratio calculating step, the supply amount calculating step, the paint supplying step, the mixing step, and the transfer step may be performed during the normal painting step.

According to this method, it is possible to selectively paint the workpiece with the normal color paint and the special color paint. Furthermore, it is possible to prepare the special color paint while painting the workpiece with the normal color paint, and therefore it is possible to perform the operation of switching the paint color even more efficiently.

In the painting method described above, the normal painting step may include a first normal painting step of painting the workpiece with a first paint supplied from the paint supply apparatus to the intermediate storage section without passing through the mixing apparatus; and a second normal painting step of painting the workpiece with a second paint supplied from the paint supply apparatus to the intermediate storage section without passing through the mixing apparatus, after the first normal painting step is finished, and the first paint and the second paint may be different colors.

According to this method, it is possible to paint the workpiece with two types of normal color paint (the first paint and second paint) while preparing the special color paint.

In the painting method described above, the first normal painting step may include a first paint supplying step of supplying the first paint from the paint supply apparatus to the intermediate storage section without passing through the mixing apparatus; a first paint transfer step of transferring the first paint in the intermediate storage section to the storage section; and a first painting step of painting the workpiece with the first paint in the storage section, the second normal painting step may include a second paint supplying step of supplying the second paint from the paint supply apparatus to the intermediate storage section without passing through the mixing apparatus; a second paint transfer step of transferring the second paint in the intermediate storage section to the storage section; and a second painting step of painting the workpiece with the second paint in the storage section, and the second paint supplying step may be performed during the first painting step.

According to this method, since the second paint supplying step is performed during the first painting step, it is possible to efficiently paint the workpiece with two types of normal color paint.

The painting method described above may comprise a first cleaning step of cleaning the intermediate storage section during the first painting step; and a second cleaning step of cleaning the storage section during the second paint supplying step.

According to this method, it is possible to efficiently clean the storage section and the intermediate storage section.

According to the present invention, it is possible to transfer the paint that has been mixed and toned by the mixing apparatus to the storage section, and therefore it is possible to clean the mixing apparatus while painting the workpiece with the paint inside the storage section. Accordingly, it is possible to efficiently perform the operation of switching the paint color.

### BRIEF DESCRIPTION OF DRAWINGS

FIG. 1 is a schematic configurational view of a painting system according to an embodiment of the present invention;

FIG. 2 is a schematic block diagram of the painting system of FIG. 1;

FIG. 3 is a timing chart describing the painting method using the painting system of FIG. 2;

FIG. 4 is a descriptive diagram of a first operation of the painting method of FIG. 3;

FIG. 5 is a descriptive diagram of a second operation of the painting method of FIG. 3;

FIG. 6 is a descriptive diagram of a third operation of the painting method of FIG. 3;

FIG. 7 is a descriptive diagram of a fourth operation of the painting method of FIG. 3;

FIG. 8 is a descriptive diagram of a fifth operation of the painting method of FIG. 3;

FIG. 9 is a descriptive diagram of a sixth operation of the painting method of FIG. 3;

FIG. 10 is a descriptive diagram of a seventh operation of the painting method of FIG. 3;

FIG. 11 is a descriptive diagram of an eighth operation of the painting method of FIG. 3;

FIG. 12 is a descriptive diagram of a ninth operation of the painting method of FIG. 3; and

FIG. 13 is a schematic block diagram of a painting system according to a modification.

### DESCRIPTION OF EMBODIMENTS

The following describes examples preferred embodiments of a painting system according to the present invention, in relation to a painting method using this painting system, while referencing the accompanying drawings.

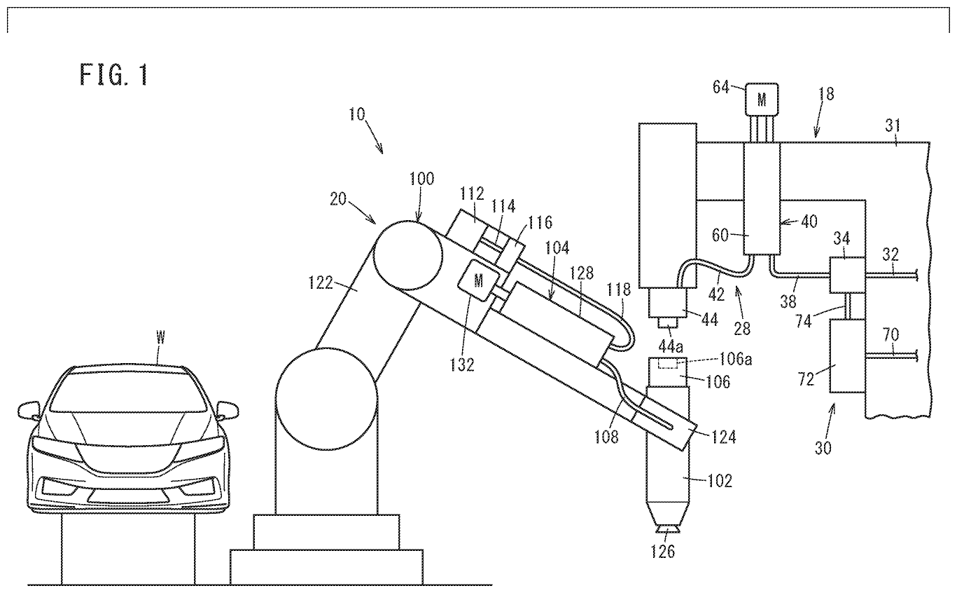

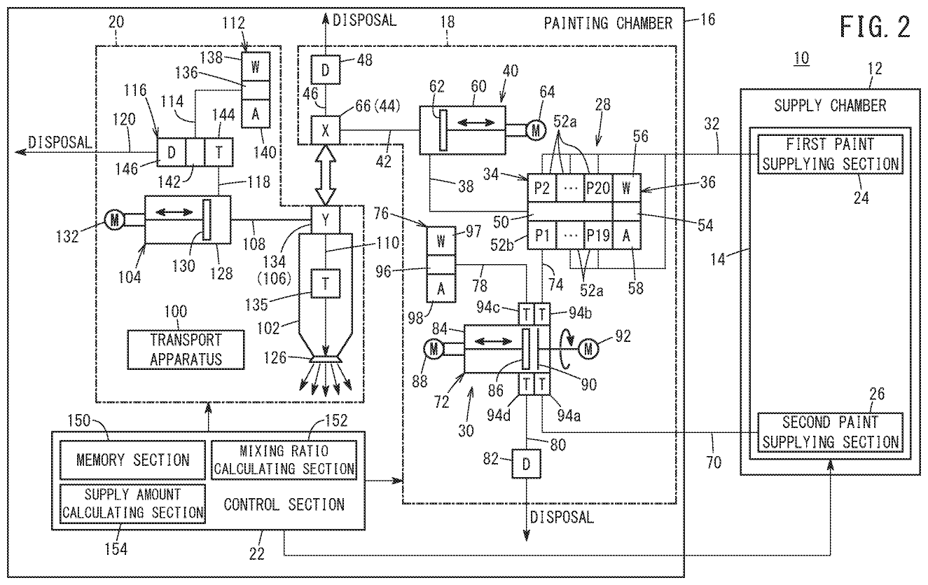

As shown in FIGS. 1 and 2, a painting system 10 is a system that mixes and tones a plurality of colors of paint, supplied from a paint supply apparatus 14, with a mixing apparatus 72 and paints a vehicle body W serving as a workpiece. However, the workpiece is not limited to being the vehicle body W.

As shown in FIG. 2, the painting system 10 includes the paint supply apparatus 14 that is installed within a supply chamber 12, and a paint transfer apparatus 18, a painting apparatus 20, and a control section 22 that are installed within a panting chamber 16. The inside of the supply chamber 12 and the inside of the panting chamber 16 are separated from each other by a wall or the like.

The paint supply apparatus 14 includes a first paint supplying section 24 and a second paint supplying section 26. The first paint supplying section 24 is a section for supplying normal color paint to the paint transfer apparatus 18. Here, normal color paint is paint of a color normally used to paint the vehicle body W. In other words, the normal color paint is used as-is to paint the vehicle body W, and can be used without mixing and toning a plurality of colors of paint. The first paint supplying section 24 includes a plurality of tanks (not shown in the drawings) for storing the normal color. Furthermore, the first paint supplying section 24 may include a pump for sending the paint stored in each tank to the paint transfer apparatus 18.

The second paint supplying section 26 is a section for supplying the paint transfer apparatus 18 with paint of the color necessary for mixing and toning special color paint. The second paint supplying section 26 includes a plurality of tanks (not shown in the drawings) for storing a plurality of colors of paint. The second paint supplying section 26 may include a pump for sending the paint stored in each tank to the paint transfer apparatus 18. The paint of the second paint supplying section 26 may be normal color paint.

In FIGS. 1 and 2, the paint transfer apparatus 18 is an apparatus for transferring, to the painting apparatus 20, the paint supplied from the paint supply apparatus 14. The paint transfer apparatus 18 is positioned on the side of the painting apparatus 20 opposite the vehicle body W, in a manner to sandwich the painting apparatus 20 between the paint transfer apparatus 18 and the vehicle body W.

The paint transfer apparatus 18 includes a first transferring section 28, a second transferring section 30 that mixes and tones a plurality of colors of paint and transfers this paint, and a support section 31 that supports the first transferring section 28 and the second transferring section 30 (see FIG. 1). The first transferring section 28 includes a first inlet passage 32, a CCV 34, a first cleaning section 36, an outlet passage 38, an intermediate storage section 40, a first transfer passage 42, a first connecting section 44, a first drain passage 46, and a first drain valve 48.

The first inlet passage 32 is a passage for introducing each color of paint of the first paint supplying section 24 to the CCV 34, and a plurality of first inlet passages 32 corresponding to the number of normal colors are provided. The CCV 34 is configured as a color change valve for selectively guiding a plurality of normal color paints and special color paints to the outlet passage 38. The CCV 34 includes a paint port 50, a first supply valve 52a, and a second supply valve 52b. The paint port 50 is in communication with the inside of the outlet passage 38.

The first supply valve 52a is a valve for supplying the paint port 50 with the normal color paint, and a plurality of these first supply valves 52a are provided. Each first supply valve 52a is connected to the first inlet passage 32. Each first supply valve 52a is configured to be capable of switching between an open state in which the inside of the first inlet passage 32 and the paint port 50 are in communication with each other and a closed state in which communication between inside of the first inlet passage 32 and the paint port 50 is cut off, based on a signal from the control section 22.

The second supply valve 52b is a valve for supplying the special color paint to the paint port 50, and one second supply valve 52b is provided. The second supply valve 52b is connected to an intermediate passage 74, described further below, that forms the second transferring section 30. The second supply valve 52b is configured to be capable of switching between an open state in which the inside of the intermediate passage 74 and the paint port 50 are in communication with each other and a closed state in which communication between the inside of the intermediate passage 74 and the paint port 50 is cut off, based on a signal from the control section 22.

The first cleaning section 36 is a section for cleaning the paint remaining in the paint port 50 of the CCV 34, the outlet passage 38, the intermediate storage section 40, the first transfer passage 42, and the first connecting section 44 when the operation of changing the color of the paint is performed, and is provided integrally with the CCV 34. The first cleaning section 36 includes a first cleaning port 54, a first cleaning liquid supply valve 56, and a first air supply valve 58.

The first cleaning port 54 is in communication with the paint port 50. The first cleaning liquid supply valve 56 is configured to be capable of switching between an open state in which a cleaning liquid such as water is allowed to flow into the first cleaning port 54 and a closed state in which the cleaning liquid is prohibited from flowing into the first cleaning port 54, based on a signal from the control section 22. The first air supply valve 58 is configured to be capable of switching between an open state in which air (pressurized air) is allowed to flow into the first cleaning port 54 and a closed state in which air is prohibited from flowing into the first cleaning port 54, based on a signal from the control section 22.

The outlet passage 38 guides the fluid that has been guided from the paint port 50 of the CCV 34, to the intermediate storage section 40. The intermediate storage section 40 is capable of storing paint, and is configured to be able to guide the stored paint out to a storage section 104. A plurality of normal color paints and special color paints are selectively stored in the intermediate storage section 40.

The intermediate storage section 40 includes a first cylinder 60, a first piston 62, and a first piston driving section 64. The first cylinder 60 is configured to be capable of storing paint. The first piston 62 is arranged to be capable of sliding inside the first cylinder 60. The first piston driving section 64 is a servo motor, for example, and moves the first piston 62 in an axial direction. The rotational movement of the first piston driving section 64 is converted into linear motion by a motive force converting section, and transmitted to the first piston 62.

The first transfer passage 42 guides the paint inside the first cylinder 60 to the first connecting section 44. The first connecting section 44 is configured to be capable of being attached to and detached from a second connecting section 106, described further below, that forms the painting apparatus 20. A protruding portion 44a, which is capable of being fitted into a recessed portion 106a of the second connecting section 106, is formed in the first connecting section 44 (see FIG. 1). Instead, a recessed portion may be formed in the first connecting section 44, and a protruding portion capable of being fitted into the recessed portion of the first connecting section 44 may be formed on the second connecting section 106.

The first connecting section 44 is provided with a first connection valve 66. When the second connecting section 106 is attached to the first connecting section 44, the first connection valve 66 is opened and allows paint to flow from the first transfer passage 42 to a second connection valve 134. When the second connecting section 106 is removed from the first connecting section 44, the first connection valve 66 is closed and prevents the fluid within the first transfer passage 42 from leaking to the outside.

The first drain passage 46 is a passage for disposing of cleaning fluid (the cleaning liquid and air), and is connected to the first connecting section 44. The first drain valve 48 opens and closes the first drain passage 46, based on a signal from the control section 22.

The second transferring section 30 includes a second inlet passage 70, a mixing apparatus 72, an intermediate passage 74, a second cleaning section 76, a cleaning passage 78, a second drain passage 80, and a second drain valve 82. The second inlet passage 70 is a passage for introducing the paint of the second paint supplying section 26 to the mixing apparatus 72, and a plurality of second inlet passages 70 are provided corresponding to the number of colors of the second paint supplying section 26.

The mixing apparatus 72 is an apparatus for mixing and toning the plurality of colors of paint. The mixing apparatus 72 includes a mixing cylinder 84, a mixing piston 86, a mixing piston driving section 88, a stirring section 90, a stirring driving section 92, and a plurality of trigger valves 94a to 94d. The mixing cylinder 84, the mixing piston 86, and the mixing piston driving section 88 are configured in the same manner as the first cylinder 60, the first piston 62, and the first piston driving section 64 described above, and therefore detailed descriptions thereof are omitted.

Each trigger valve 94a to 94d is provided on the mixing cylinder 84. The trigger valve 94a is configured to be capable of switching between an open state in which the inside of the second inlet passage 70 and the inside of the mixing cylinder 84 are in communication with each other and a closed state in which the communication between the inside of the second inlet passage 70 and the inside of the mixing cylinder 84 is cut off. The trigger valve 94b is configured to be capable of switching between an open state in which the inside of the intermediate passage 74 and the inside of the mixing cylinder 84 are in communication with each other and a closed state in which the communication between the inside of the intermediate passage 74 and the inside of the mixing cylinder 84 is cut off.

The trigger valve 94c is configured to be capable of switching between an open state in which the inside of the cleaning passage 78 and the inside of the mixing cylinder 84 are in communication with each other and a closed state in which the communication between the inside of the cleaning passage 78 and the inside of the mixing cylinder 84 is cut off. The trigger valve 94d is configured to be capable of switching between an open state in which the inside of the second drain passage 80 and the inside of the mixing cylinder 84 are in communication with each other and a closed state in which the communication between the inside of the second drain passage 80 and the inside of the mixing cylinder 84 is cut off. Each trigger valve 94a to 94d is switched between the open state and the closed state based on a signal from the control section 22.

The intermediate passage 74 guides the paint that has been mixed and toned by the mixing apparatus 72 (special color paint) to the second supply valve 52b of the CCV 34. The second cleaning section 76 includes a second cleaning port 96, a second cleaning liquid supply valve 97, and a second air supply valve 98. The second cleaning port 96 is in communication with the inside of the cleaning passage 78. The second cleaning liquid supply valve 97 and the second air supply valve 98 are configured in the same manner as the first cleaning liquid supply valve 56 and the first air supply valve 58 described above, and therefore detailed descriptions thereof are omitted. The cleaning passage 78 guides the cleaning fluid to the inside of the mixing cylinder 84.

The second drain passage 80 is a passage for disposing the cleaning fluid inside the mixing cylinder 84. The second drain valve 82 opens and closes the second drain passage 80 based on a signal from the control section 22.

As shown in FIGS. 1 and 2, the painting apparatus 20 is an apparatus for painting the vehicle body W with the paint transferred from the paint transfer apparatus 18. The painting apparatus 20 includes a transport apparatus 100, a painting section 102, the storage section 104, the second connecting section 106, a second transfer passage 108, a painting passage 110, a third cleaning section 112, a first cleaning passage 114, a switching valve 116, a second cleaning passage 118, and a third drain passage 120.

In FIG. 1, the transport apparatus 100 includes a multi-jointed (articulated) robot arm 122 and a gripping portion 124 that is provided at the tip of the robot arm 122 and grips the painting section 102. The robot arm 122 is configured to be movable relative to the vehicle body W.

The painting section 102 is a widely known rotary atomization type of painting gun that performs electrostatic painting of the vehicle body W. The painting section 102 extends in one direction. A rotary atomizing section 126 for spraying the paint toward the vehicle body W is provided on one end of the painting section 102. The rotary atomizing section 126 charges the paint to a negative polarity and atomizes the paint, in order to efficiently apply the paint to the grounded vehicle body W. However, the painting section 102 is not limited to a rotary atomization type of painting gun.

The storage section 104 is configured to be capable of storing the paint transferred from the paint transfer apparatus 18 (the normal color paint and special color paint), and is provided near the painting section 102 on the robot arm 122. The storage section 104 includes a second cylinder 128, a second piston 130, and a second piston driving section 132. The second cylinder 128, the second piston 130, and the second piston driving section 132 are configured in the same manner as the first cylinder 60, the first piston 62, and the first piston driving section 64 described above, and therefore detailed descriptions thereof are omitted.

The second connecting section 106 is provided to the second transfer passage 108 for guiding the paint to the storage section 104 while being positioned at the other end of the painting section 102. The second connection valve 134 is provided to the second connecting section 106. When the second connecting section 106 is attached to the first connecting section 44, the second connection valve 134 is opened and allows the paint to flow from the first connection valve 66 to the second transfer passage 108. When the second connecting section 106 is removed from the first connecting section 44, the second connection valve 134 is closed to cause the second transfer passage 108 and the painting passage 110 to be in communication with each other and also to prohibit the fluid (paint, cleaning fluid, or the like) from leaking to the outside.

The painting passage 110 connects the second connecting section 106 and the rotary atomizing section 126 to each other. The painting passage 110 is provided with a trigger valve 135 that is capable of opening and closing the painting passage 110 based on a signal from the control section 22.

The third cleaning section 112 includes a third cleaning port 136, a third cleaning liquid supply valve 138, and a third air supply valve 140. The third cleaning port 136 is in communication with the inside of the first cleaning passage 114. The third cleaning liquid supply valve 138 is configured in the same manner as the first cleaning liquid supply valve 56 and the second cleaning liquid supply valve 97 described above, and therefore a detailed description thereof is omitted. Furthermore, the third air supply valve 140 is configured in the same manner as the first air supply valve 58 and the second air supply valve 98 described above, and therefore a detailed description thereof is omitted.

The switching valve 116 includes an intermediate port 142, a trigger valve 144, and a third drain valve 146. The intermediate port 142 is in communication with the inside of the first cleaning passage 114. The trigger valve 144 is configured to be capable of switching between an open state in which the intermediate port 142 and the inside of the second cleaning passage 118 are in communication with each other and a closed state in which communication between the intermediate port 142 and the inside of the second cleaning passage 118 is cut off, based on a signal from the control section 22.

The second cleaning passage 118 is in communication with the inside of the second cylinder 128. The third drain valve 146 is configured to be capable of switching between an open state in which the intermediate port 142 and the inside of the third drain passage 120 are in communication with each other and a closed state in which communication between the intermediate port 142 and the inside of the third drain passage 120 is cut off, based on a signal from the control section 22. The third drain passage 120 is a passage for disposing of the cleaning fluid inside the second cylinder 128.

The control section 22 controls the paint supply apparatus 14, the paint transfer apparatus 18, and the painting apparatus 20. The control section 22 includes a memory section 150, a mixing ratio calculating section 152, and a supply amount calculating section 154. The memory section 150 stores painting information (the color of the paint to be applied, the amount of paint necessary for the painting, and the like) for the vehicle body W. The mixing ratio calculating section 152 calculates the mixing ratio of a plurality of colors of paint needed for toning, based on the paint information in the memory section 150, when the vehicle body W is to be painted the special color. The supply amount calculating section 154 calculates the supply amount each color of paint to be supplied from the paint supply apparatus 14 to the mixing apparatus 72, based on the calculated mixing ratio and the painting information in the memory section 150.

The following describes the operation of the painting system 10, with relation to the painting method. Here, an example is described in which painting of a first vehicle body W is performed with a normal color paint (first normal painting step), painting of a second vehicle body W is performed with a normal color paint that is a different color than the paint used for the first vehicle body W (second normal painting step), and a third vehicle body W is painted with a special color (special painting step). In the following example, the first vehicle body W is referred to as the first vehicle body W1, the second vehicle body W is referred to as the second vehicle body W2, and the third vehicle body W is referred to as the third vehicle body W3. Furthermore, the normal color paint used to paint the first vehicle body W1 is referred to as the first paint, the normal color paint used to paint the second vehicle body W2 is referred to as the second paint, and the special color paint used to paint the third vehicle body W3 is referred to as the third paint.

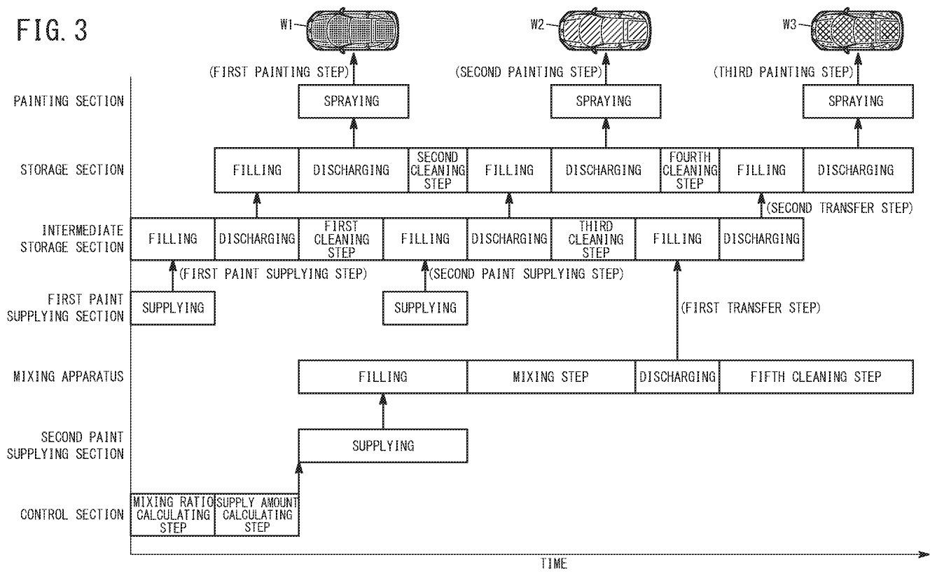

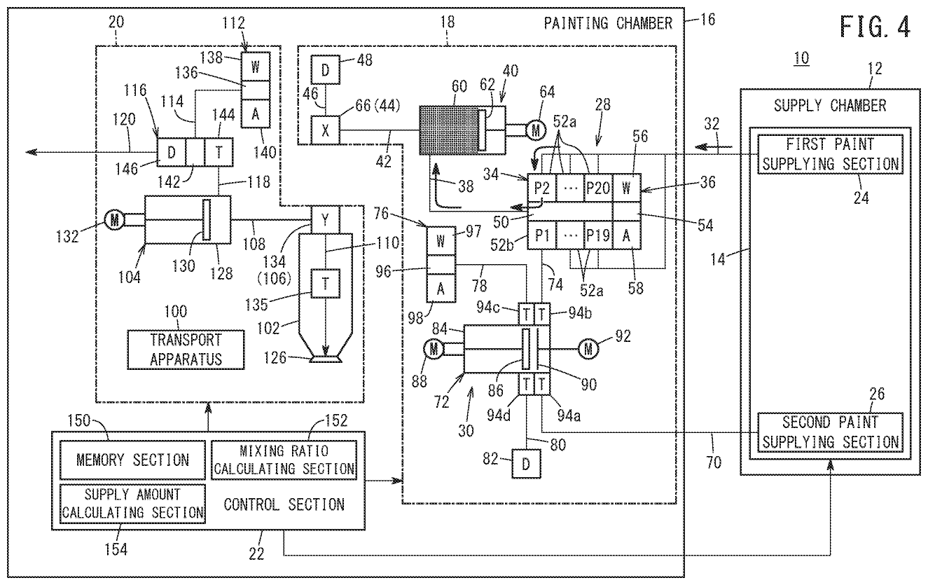

First, as shown in FIGS. 3 and 4, when the first normal painting step is performed, the first paint is supplied from the first paint supplying section 24 to the inside of the first cylinder 60 of the intermediate storage section 40, via the CCV 34 (first paint supplying step). Specifically, the control section 22 drives the first piston driving section 64 of the intermediate storage section 40 to move the first piston 62 in a manner to increase the volume inside the first cylinder 60, and opens a prescribed first supply valve 52a of the CCV 34. Due to this, the inside of the first cylinder 60 of the intermediate storage section 40 becomes a negative pressure, and the first paint of the first paint supplying section 24 fills the inside of the first cylinder 60 via the first inlet passage 32, the CCV 34, and the outlet passage 38. At this time, if the first paint supplying section 24 includes a pump, the first paint may be discharged into the inside of the first cylinder 60 by the effect of this pump.

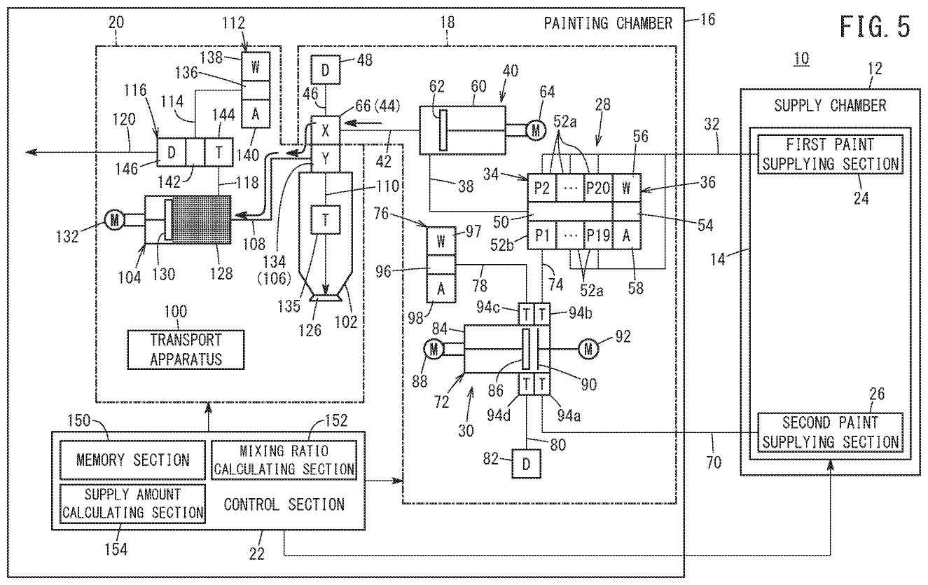

Next, as shown in FIGS. 3 and 5, in a state where the second connecting section 106 is attached to the first connecting section 44, the first paint in the intermediate storage section 40 is transferred to the storage section 104. Specifically, the control section 22 drives the first piston driving section 64 to move the first piston 62 in a manner to decrease the volume inside the first cylinder 60 and also drives the second piston driving section 132 of the storage section 104 to move the second piston 130 in a manner to increase the volume inside the second cylinder 128. Due to this, the first paint derived from the inside of the first cylinder 60 is transferred to the inside of the second cylinder 128, via the first transfer passage 42, the first connecting section 44, the second connecting section 106, and the second transfer passage 108.

Furthermore, the special painting step is started while the first paint of the first paint supplying section 24 is filling the inside of the second cylinder 128. Specifically, the mixing ratio calculating section 152 calculates the mixing ratio of primary color paints necessary for toning the third paint (mixing ratio calculating step). The supply amount calculating section 154 then calculates the supply amount of each color of paint to be supplied to the mixing apparatus 72, based on the calculated mixing ratio (supply amount calculating step).

After this, in the first normal painting step, in a state where the second connecting section 106 has been removed from the first connecting section 44, the control section 22 paints the first vehicle body W with the first paint, while controlling the robot arm 122 (first painting step). Specifically, the control section 22 drives the second piston driving section 132 to move the second piston 130 in a manner to reduce the volume inside the second cylinder 128. Due to this, the first paint derived from inside the second cylinder 128 is sprayed toward the first vehicle body W1 from the rotary atomizing section 126, via the second transfer passage 108, the second connecting section 106, and the painting passage 110.

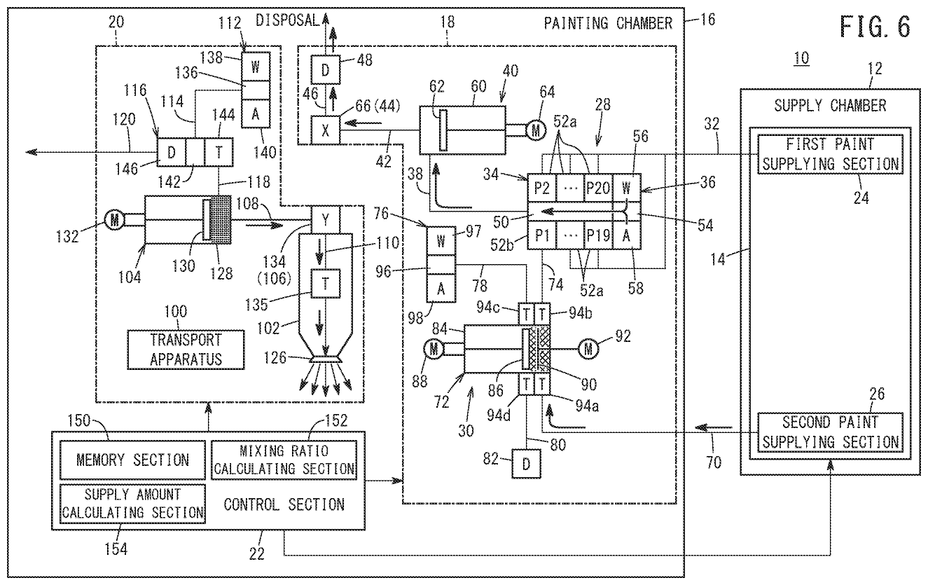

As shown in FIGS. 3 and 6, while this first painting step is being performed, the control section 22 controls the first cleaning section 36 to clean the intermediate storage section 40 (first cleaning step). Specifically, the cleaning fluid (cleaning liquid and air) is supplied from the first cleaning section 36 to the inside of the first cylinder 60 of the intermediate storage section 40, via the paint port 50 of the CCV 34 and the outlet passage 38. Furthermore, by moving the first piston 62 while the first drain valve 48 is in the open state, the cleaning fluid inside the first cylinder 60 is disposed of via the first transfer passage 42, the first connection valve 66, and the first drain passage 46. Due to this, the paint port 50 of the CCV 34, the outlet passage 38, the intermediate storage section 40, the first transfer passage 42, and the first connecting section 44 are cleaned.

Furthermore, when the first painting is being performed, the plurality of colors of paint are supplied to the inside of the mixing cylinder 84 of the mixing apparatus 72 from the second paint supplying section 26. Specifically, the control section 22 drives the mixing piston driving section 88 of the mixing apparatus 72 to move the mixing piston 86 in a manner to increase the volume inside the mixing cylinder 84 and also opens the trigger valve 94a. Due to this, the inside of the mixing cylinder 84 becomes a negative pressure, and therefore the inside of the mixing cylinder 84 is filled with the plurality of colors of paint from the second paint supplying section 26, via the second inlet passage 70 and the trigger valve 94a. At this time, if the second paint supplying section 26 includes a pump, the plurality of colors of paint may be discharged into the inside of the mixing cylinder 84 by the effect of this pump. Furthermore, at this time, after the inside of the mixing cylinder 84 has been filled with a first color of paint, the inside of the mixing cylinder 84 may be filled with the next color of paint while the stirring section 90 rotates. In this way, even if the viscosity of the paint is relatively high, it is possible to efficiently mix the plurality of colors of paint.

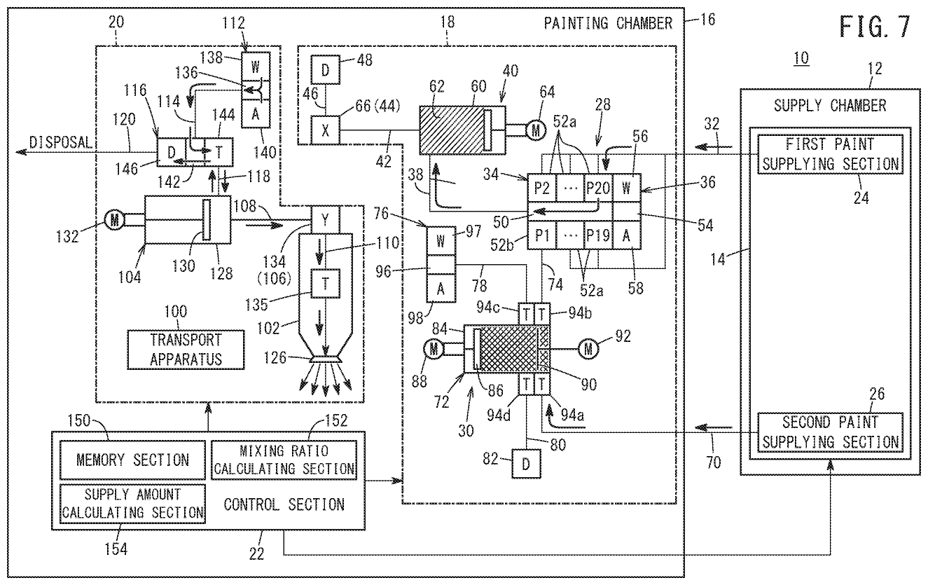

Then, when the first cleaning step is finished, as shown in FIGS. 3 and 7, the second paint is supplied from the first paint supplying section 24 to the inside of the first cylinder 60, via the CCV 34 (second paint supplying step). This second paint supplying step is basically performed in the same manner as the first paint supplying step, and therefore a detailed description thereof is omitted. It should be noted that, in the second paint supplying step, a first supply valve 52a of the CCV 34 (a first supply valve 52a that is different from the first supply valve 52a opened in the first paint supplying step) is opened. In this way, the inside of the first cylinder 60 is filled with the second paint.

While this third paint supplying step is being performed, the control section 22 controls the third cleaning section 112 to clean the storage section 104 (second cleaning step). Specifically, the cleaning fluid (cleaning liquid and air) is supplied from the third cleaning section 112 to the inside of the second cylinder 128 of the storage section 104, via the first cleaning passage 114, the switching valve 116, and the second cleaning passage 118. Then, by stopping the supply of the cleaning fluid from the third cleaning section 112 and moving the second piston 130 while the trigger valve 144 and the third drain valve 146 are in the open state, the cleaning fluid inside the second cylinder 128 is disposed of via the second cleaning passage 118, the trigger valve 144, the intermediate port 142, the third drain valve 146, and the third drain passage 120. At this time, the cleaning fluid inside the second cylinder 128 is discharged to the outside from the rotary atomizing section 126 via the second transfer passage 108, the second connecting section 106, and the painting passage 110. In this way, the storage section 104, the second transfer passage 108, the second connecting section 106, the painting passage 110, and the rotary atomizing section 126 are cleaned.

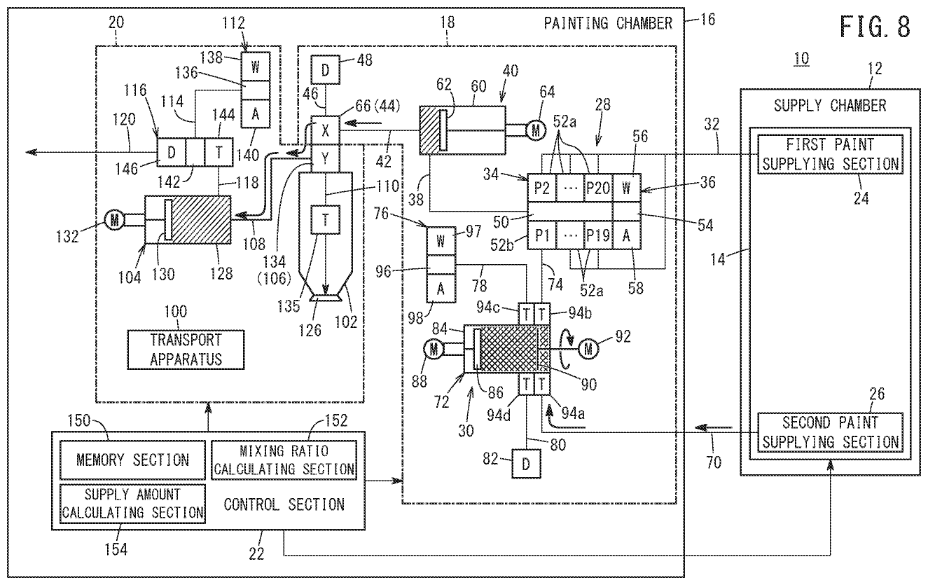

After this, as shown in FIGS. 3 and 8, in a state where the second connecting section 106 is attached to the first connecting section 44, the second paint in the intermediate storage section 40 is transferred to the storage section 104. Furthermore, at this time, the mixing apparatus 72 mixes and tones the plurality of colors of paint inside the mixing cylinder 84 (mixing step). Specifically, the stirring section 90 is rotated due to the control section 22 driving the stirring driving section 92. In this way, the third paint is obtained by stirring together the plurality of colors of paint inside the mixing cylinder 84.

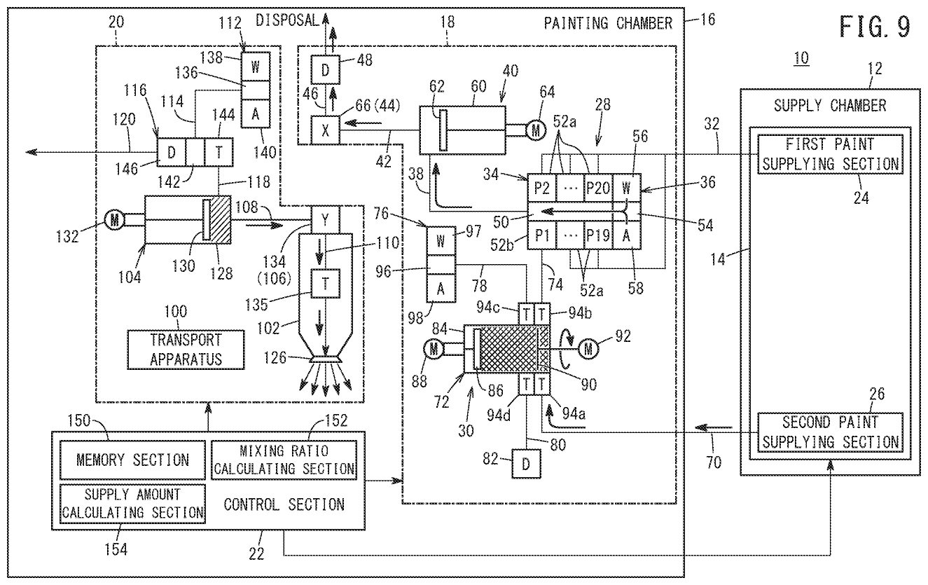

When the transfer of the second paint to the storage section 104 is finished, as shown in FIGS. 3 and 9, in a state where the second connecting section 106 has been removed from the first connecting section 44, the control section 22 paints the second vehicle body W2 with the second paint while controlling the robot arm 122 (second painting step). The second painting step and the third painting step, which is described further below, are performed in the same manner as the first painting step described above, and therefore detailed descriptions thereof are omitted.

While this second painting step is being performed, the control section 22 controls the first cleaning section 36 to clean the intermediate storage section 40 (third cleaning step). The third cleaning step is performed in the same manner as the first cleaning step described above, and therefore a detailed description thereof is omitted.

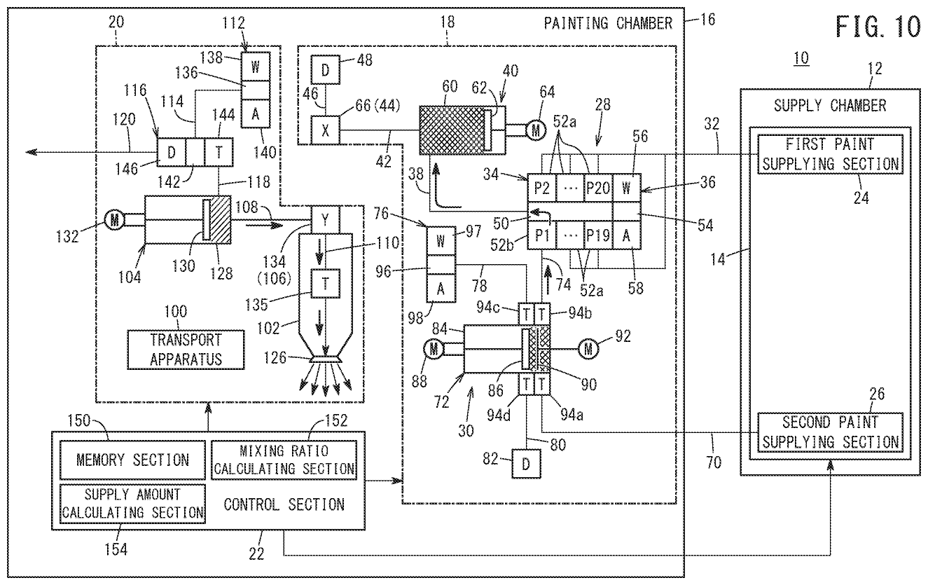

Then, when the third cleaning step is finished, as shown in FIGS. 3 and 10, the third paint is transferred from the mixing apparatus 72 to the inside of the first cylinder 60 of the intermediate storage section 40, via the CCV 34 (first transfer step). Specifically, the control section 22 opens the second supply valve 52b of the CCV 34 and the trigger valve 94b, drives the mixing piston driving section 88 to move the mixing piston 86 in a manner to decrease the volume inside the mixing cylinder 84, and drives the first piston driving section 64 to move the first piston 62 in a manner to increase the volume inside the first cylinder 60. Due to this, the third paint inside the mixing cylinder 84 fills the inside of the first cylinder 60, via the intermediate passage 74, the second supply valve 52b of the CCV 34, the paint port 50, and the outlet passage 38.

While this first transfer step is being performed, the control section 22 controls the third cleaning section 112 to clean the storage section 104 (fourth cleaning step). The fourth cleaning step is performed in the same manner as the second cleaning step described above, and therefore a detailed description thereof is omitted.

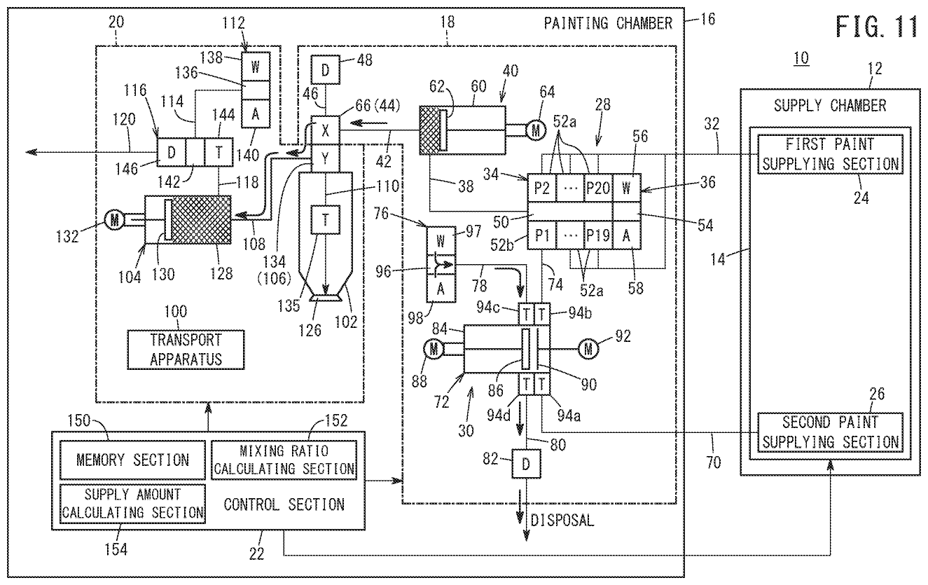

After this, as shown in FIGS. 3 and 11, in a state where the second connecting section 106 is attached to the first connecting section 44, the third paint in the intermediate storage section 40 is transferred to the storage section 104 (second transfer step).

Furthermore, while this second transfer step is being performed, in preparation for the painting with the next special color, the control section 22 controls the second cleaning section 76 to clean the mixing apparatus 72 (fifth cleaning step). Specifically, while the trigger valve 94c is in the open state, the control section 22 supplies the cleaning fluid (cleaning liquid and air) from the second cleaning section 76 to the inside of the mixing cylinder 84, via the cleaning passage 78. Then, the control section 22 closes the trigger valve 94c and moves the mixing piston 86 while the trigger valve 94d and the second drain valve 82 are in the open state, thereby disposing of the cleaning fluid inside the mixing cylinder 84 via the second drain passage 80.

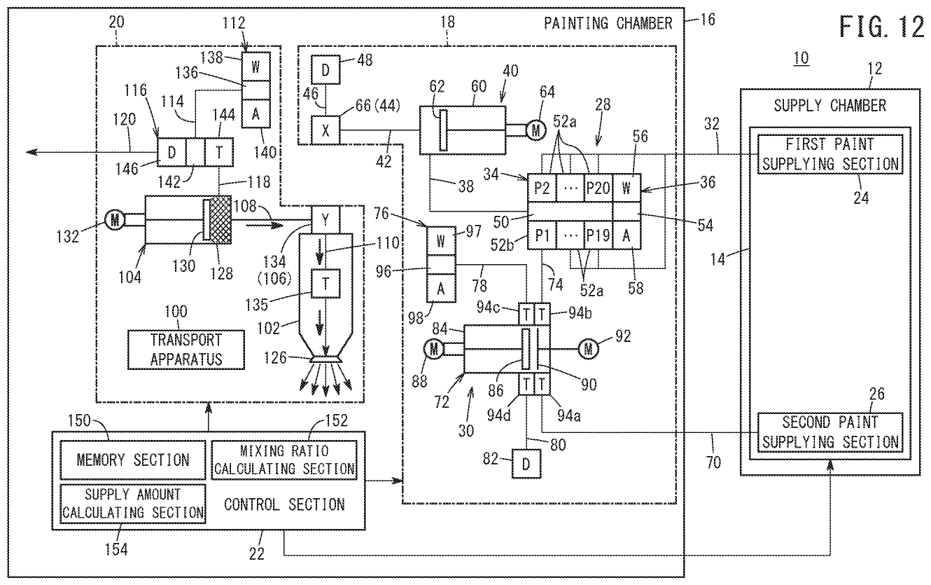

When the second transfer step is finished, as shown in FIGS. 3 and 12, in a state where the second connecting section 106 has been removed from the first connecting section 44, the control section 22 paints the third vehicle body W3 with the third paint while controlling the robot arm 122 (third painting step).

In this case, the painting system 10 and the painting method according to the present invention realize the effects described below.

The painting system 10 includes the mixing apparatus 72 that is capable of mixing and toning the plurality of colors of paint supplied from the paint supply apparatus 14, and a storage section 104 that is capable of storing the paint that has been mixed and toned by the mixing apparatus 72. Therefore, it is possible to clean the mixing apparatus 72 while painting the vehicle body W (third vehicle body W3) using the special color paint inside the storage section 104. In other words, it is possible to perform the fifth cleaning step during the third painting step. Accordingly, it is possible to efficiently perform the operation of switching the paint color.

The painting system 10 further includes the intermediate storage section 40 that is capable of storing the paint mixed and toned by the mixing apparatus 72, and the paint stored inside the intermediate storage section 40 can be transferred to the storage section 104. As a result, it is possible to transfer the special color paint mixed and toned by the mixing apparatus 72 to the intermediate storage section 40 while painting the vehicle body W (second vehicle body W2) using the paint (normal color paint) inside the storage section 104. Therefore, it is possible to even more efficiently perform the operation of switching the paint color.

The painting system 10 includes the CCV 34 for selectively guiding the paint (normal color paint) supplied from the paint supply apparatus 14 without passing through the mixing apparatus 72 and the paint (special color paint) mixed and toned by the mixing apparatus 72 to the intermediate storage section 40. Therefore, it is possible to paint the vehicle body W selectively with the normal color paint and special color paint. Furthermore, since it is possible to share (commonize) the intermediate storage section 40, the storage section 104, and the painting section 102 between a case where the vehicle body W is painted with the normal color paint and a case where the vehicle body W is painted with the special color paint, it is possible to make the painting system 10 more compact and to lower equipment costs.

The painting system 10 includes the first transfer passage 42 through which the paint inside the intermediate storage section 40 is guided and the first connecting section 44 provided to the first transfer passage 42. Furthermore, the painting system 10 includes the second connecting section 106 that is capable of being attached to and detached from the first connecting section 44, and the second transfer passage 108 that causes the second connecting section 106 and the storage section 104 to be coupled with each other. In a state where the first connecting section 44 and the second connecting section 106 are attached to each other, the paint inside the intermediate storage section 40 can be transferred to the inside of the storage section 104 via the first transfer passage 42, the first connecting section 44, the second connecting section 106, and the second transfer passage 108.

Therefore, when it is necessary to supply paint to the storage section 104, it is possible to transfer the paint in the intermediate storage section 40 to the storage section 104 by attaching the second connecting section 106 to the first connecting section 44. Furthermore, when the vehicle body W is to be painted, it is possible to separate the intermediate storage section 40 and the storage section 104 from each other by removing the second connecting section 106 from the first connecting section 44. Accordingly, there is no need to lengthen the passage between the intermediate storage section 40 and the storage section 104 to match the operating range of the transport apparatus 100.

In the painting method using the painting system 10, the first normal painting step, the second normal painting step, and the special painting step are performed. As shown in FIG. 3, the mixing ratio calculating step, the supply amount calculating step, and the paint supplying step (second paint supplying step) of the special painting step are performed during the first normal painting step. Furthermore, the paint supplying step (second paint supplying step), the mixing step, and the first transfer step are performed during the second normal painting step. Therefore, it is possible to paint the vehicle body W selectively with the normal color paint and the special color paint. Furthermore, since it is possible to prepare the special color paint while painting the vehicle body W with the normal color paint (first normal painting step and second normal painting step), it is possible to more efficiently perform the operation of changing the paint color.

In the first normal painting step, the vehicle body W is painted with the first paint supplied from the paint supply apparatus 14 to the intermediate storage section 40 without passing through the mixing apparatus 72. In the second normal painting step, the vehicle body W is painted with the second paint supplied from the paint supply apparatus 14 to the intermediate storage section 40 without passing through the mixing apparatus 72, after the first normal painting step is finished. The first paint and the second paint are different colors. Therefore, it is possible to paint the vehicle body W with two different types of normal color paint (first paint and second paint) while preparing the special color paint.

In the first normal painting step, a first paint supplying step of supplying the first paint from the paint supply apparatus 14 to the intermediate storage section 40 without passing through the mixing apparatus 72, a first paint transfer step of transferring the first paint in the intermediate storage section 40 to the storage section 104, and a first painting step of painting the vehicle body W with the first paint in the storage section 104 are performed. In the second normal painting step, a second paint supplying step of supplying the second paint from the paint supply apparatus 14 to the intermediate storage section 40 without passing through the mixing apparatus 72, a second paint transfer step of transferring the second paint in the intermediate storage section 40 to the storage section 104, and a second painting step of painting the vehicle body W with the second paint in the storage section 104 are performed. The second paint supplying step is performed during the first painting step.

Therefore, since the second paint supplying step is performed during the first painting step, it is possible to efficiently paint the vehicle body W with two types of normal color paint.

In the painting method, a first cleaning step of cleaning the intermediate storage section 40 during the first painting step and a second cleaning step of cleaning the storage section 104 during the second paint supplying step are performed.

Therefore, it is possible to efficiently clean the storage section 104 and the intermediate storage section 40.

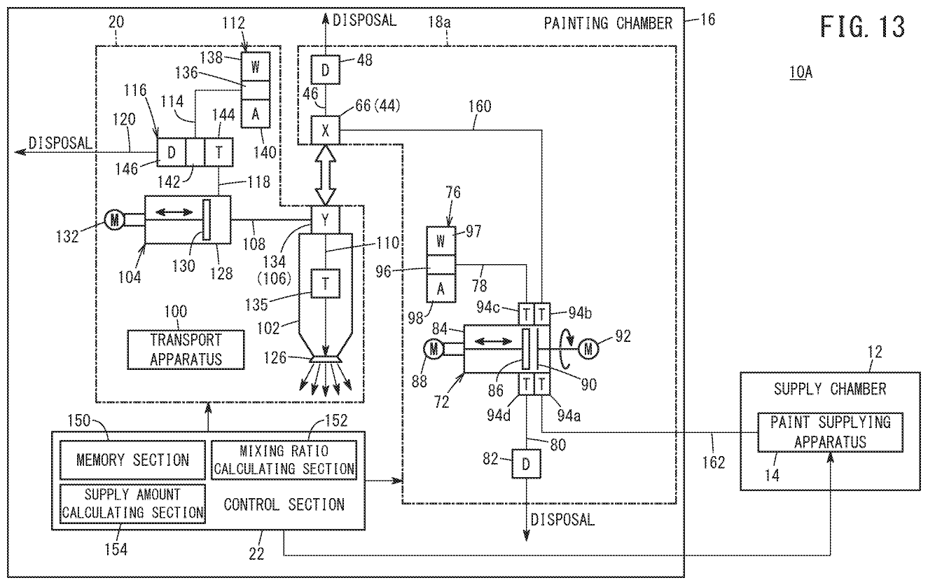

The present invention is not limited to the configuration described above. As an example, as shown in the paint transfer apparatus 18a forming the painting system 10A shown in FIG. 13, the intermediate storage section 40 and the CCV 34 described above may be omitted, and the trigger valve 94b of the mixing apparatus 72 and the first connecting section 44 may be caused to be coupled with each other by a first transfer passage 160.

In the painting method using such a painting system 10A, first, after the mixing ratio calculation step and the supply amount calculation step have been performed, the plurality of colors of paint are introduced from the paint supply apparatus 14 to the inside of the mixing apparatus 72 via an inlet passage 162 (paint supplying step). Then, the control section 22 obtains the special color paint by controlling the mixing apparatus 72 to mix and tone the plurality of colors of paint (mixing step). After this, in a state where the second connecting section 106 is attached to the first connecting section 44, the control section 22 controls the mixing apparatus 72 and the storage section 104 to transfer the special color paint inside the mixing apparatus 72 to the storage section 104, via the first transfer passage 160, the first connecting section 44, the second connecting section 106, and the second transfer passage 108 (transfer step). Next, in a state where the second connecting section 106 has been removed from the first connecting section 44, the vehicle body W is painted the special color using the special color paint inside the storage section 104 (painting step).

In this way, with the painting system 10A shown in FIG. 13, it is possible to paint the vehicle body W (workpiece) with the special color paint. Furthermore, since the special color paint inside the mixing apparatus 72 is transferred to the inside of the storage section 104, it is possible to perform a cleaning step for the mixing apparatus 72 during the painting step.

The painting system and painting method according to the present invention are not limited to the embodiments described above, and it is obvious that various configurations can be adopted without deviating from the scope of the present invention.

What is claimed is:

1. A painting system that mixes and tones a plurality of colors of paint, supplied from a paint supply apparatus, with a mixing apparatus and paints a workpiece, the painting system comprising:
a mixing ratio calculating section that calculates a mixing ratio of colors of paint necessary for toning;
a supply amount calculating section that calculates a supply amount of each color of paint based on the mixing ratio;
the paint supply apparatus that supplies the mixing apparatus with an amount of each color of paint necessary for toning corresponding to the supply amount calculated by the supply amount calculating section;
the mixing apparatus that is capable of mixing and toning the plurality of colors of paint supplied from the paint supply apparatus;
a storage section that is capable of storing the paint that has been mixed and toned by the mixing apparatus;
a painting section that is capable of painting the workpiece with the paint inside the storage section;
a transport apparatus that is provided with the storage section and transports the painting section; and
a cleaning section that is capable of cleaning the mixing apparatus.

2. The painting system according to claim 1, further comprising:
an intermediate storage section that is capable of storing the paint that has been mixed and toned by the mixing apparatus, wherein
the paint stored inside the intermediate storage section is capable of being transferred to the storage section.

3. The painting system according to claim 2, further comprising:
a color change valve for selectively guiding, to the intermediate storage section, paint supplied from the paint supply apparatus that does not pass through the mixing apparatus and paint supplied from the paint supply apparatus that has been mixed and toned by the mixing apparatus.

4. The painting system according to claim 3, further comprising:
a first transfer passage through which the paint inside the intermediate storage section is guided;
a first connecting section provided to the first transfer passage;
a second connecting section that is capable of being attached to and detached from the first connecting section; and
a second transfer passage that causes communication between the second connecting section and the storage section, wherein
in a state where the second connecting section is attached to the first connecting section, the paint inside the intermediate storage section is capable of being transferred to the inside of the storage section via the first transfer passage, the first connecting section, the second connecting section, and the second transfer passage.

5. A painting method for mixing and toning a plurality of colors of paint, supplied from a paint supply apparatus, with a mixing apparatus and painting a workpiece, the painting method comprising:
a mixing ratio calculating step of calculating a mixing ratio of colors of paint necessary for toning;
a supply amount calculating step of calculating, based on the mixing ratio calculated in the mixing ratio calculating step, a supply amount of each color of paint to be supplied from the paint supply apparatus to the mixing apparatus;
a paint supplying step of supplying the mixing apparatus with an amount of each color of paint necessary for toning corresponding to the supply amount calculated in the supply amount calculating step;
a mixing step of mixing and toning the plurality of colors of paint supplied to the mixing apparatus;
a transfer step of transferring the paint that has been mixed and toned in the mixing step to a storage section provided to a transport apparatus;
a painting step of guiding the paint inside the storage section to a painting section provided to the transport apparatus and painting the workpiece; and
a cleaning step of cleaning the mixing apparatus, wherein
the cleaning step is performed during the painting step.

6. The painting method according to claim 5, wherein
the transfer step includes:
a first transfer step of transferring the paint that has been mixed and toned in the mixing step to the intermediate storage section; and
a second transfer step of transferring the paint in the intermediate storage section to the storage section, and
the cleaning step is performed during the second transfer step.

7. The painting method according to claim 6, comprising:
a normal painting step of transferring, to the storage section, the paint supplied from the paint supply apparatus to the intermediate storage section without passing through the mixing apparatus and painting the workpiece, wherein
at least one of the mixing ratio calculating step, the supply amount calculating step, the paint supplying step, the mixing step, and the transfer step is performed during the normal painting step.

8. The painting method according to claim 7, wherein
the normal painting step includes:
a first normal painting step of painting the workpiece with a first paint supplied from the paint supply apparatus to the intermediate storage section without passing through the mixing apparatus; and
a second normal painting step of painting the workpiece with a second paint supplied from the paint supply apparatus to the intermediate storage section without passing through the mixing apparatus, after the first normal painting step is finished, and
the first paint and the second paint are different colors.

9. The painting method according to claim 8, wherein
the first normal painting step includes:
a first paint supplying step of supplying the first paint from the paint supply apparatus to the intermediate storage section without passing through the mixing apparatus;
a first paint transfer step of transferring the first paint in the intermediate storage section to the storage section; and
a first painting step of painting the workpiece with the first paint in the storage section,
the second normal painting step includes:
a second paint supplying step of supplying the second paint from the paint supply apparatus to the intermediate storage section without passing through the mixing apparatus;
a second paint transfer step of transferring the second paint in the intermediate storage section to the storage section; and
a second painting step of painting the workpiece with the second paint in the storage section, and
the second paint supplying step is performed during the first painting step.

10. The painting method according to claim 9, comprising:
a first cleaning step of cleaning the intermediate storage section during the first painting step; and
a second cleaning step of cleaning the storage section during the second paint supplying step.
